(19) United States
(12) Patent Application Publication
(10) Pub. No.: US 2022/0407162 A1
(43) Pub. Date: Dec. 22, 2022

(54) CELL CARRIER WITH INTEGRATED SIDE WALLS

(71) Applicant: Rivian IP Holdings, LLC, Plymouth, MI (US)

(72) Inventor: Tyler Jacobs, Redondo Beach, CA (US)

(21) Appl. No.: 17/353,358

(22) Filed: Jun. 21, 2021

(51) Int. Cl. H01M 50/238; H01M 10/6554; H01M 50/107; H01M 50/213

(52) U.S. Cl. CPC H01M 50/238; H01M 10/6554; H01M 50/107; H01M 50/213; H01M 2220/20

(57) ABSTRACT

A battery system for providing power to a vehicle includes a plurality of battery modules comprised of a plurality of battery cells. The battery system also includes a cell carrier that encases the plurality of battery cells. The cell carrier is comprised of a battery cell carrier connected to a plurality of walls by a plurality of hinges. The battery system is formed by receiving a cell carrier formed as a single component, folding walls of the cell carrier by flexing the plurality of integrated hinges, forming an assembly including the plurality of battery cells and the cell carrier, and applying an adhesive to the walls and the plurality of battery cells to affix the walls to the assembly. The battery system includes a shear wall affixed to a lateral side, and a cooling plate affixed to the plurality of battery cells, opposite a base of the cell carrier.

### INTRODUCTION

The present disclosure is directed towards a structural reinforcement of a battery module carrier, and more particularly, towards a battery module carrier having a plurality of multipart shear walls.

### SUMMARY

In some embodiments, the present disclosure is directed to a battery system configured to provide electric power to a vehicle. The battery system includes an assembly having a plurality of battery cells and a cell carrier. The cell carrier, which is formed as a single component and is foldable, at least partially encases the plurality of battery cells. In some embodiments, the cell carrier includes one or more walls arranged along respective edges of a rectangular base, and one or more integrated hinges, each integrated hinge arranged between a respective wall of the one or more walls and the respective edges of the rectangular base. In some embodiments, the cell carrier includes a base, a plurality of walls arranged along respective edges of the rectangular or square base, and an integrated hinge or a plurality of integrated hinges. Each integrated hinge is arranged between a respective wall of the plurality of walls and the rectangular or square base at the respective edge.

In some embodiments, the rectangular base may include a first pair of lateral sides opposite each other that are a first length, and a second pair of lateral sides that are opposite each other and that are a second length longer than the first length. In some such embodiments, the battery system includes one or more wall reinforcements affixed along the second pair of lateral sides. In some embodiments, for example, the one or more wall reinforcements include structural tabs.

In some embodiments, the cell carrier is configured to achieve a first state and a second state. The first state includes the plurality of walls and the rectangular base arranged in a single plane as a flat structure, with the integrated hinges in a unflexed state or in a first flexed state. The second state includes the plurality of walls arranged perpendicular to the rectangular base, with the integrated hinges flexed or in a second flexed state.

In some embodiments, the battery system includes an adhesive arranged along each integrated hinge to maintain an orientation of each respective wall of the plurality of walls and the rectangular base.

In some embodiments, the plurality of walls include a first wall and a second wall. The first wall is arranged at a first edge of the rectangular base, and the second wall is arranged at a second edge of the rectangular base opposite to the first edge. In some such embodiments, the battery system includes a shear wall arranged along a side of the assembly corresponding to a third edge of the rectangular base. The shear wall is affixed to the cell carrier, including one or more mounting features.

In some embodiments, the battery system includes a cooling plate having a first side and a second side opposite the first side. In some such embodiments, the plurality of battery cells each include a first face affixed to the rectangular base, and a second face opposite the first face. The second face of each battery cell is affixed to the first side of the cooling plate. In some embodiments, the battery system includes a second assembly arranged along the second side of the cooling plate. The second assembly includes a second plurality of battery cells and a second cell carrier. The second cell carrier encases the second plurality of battery cells, and includes a second rectangular base, a plurality of second walls arranged along respective edges of the second rectangular base, and a plurality of second integrated hinges. Each second integrated hinge is arranged between a respective second wall of the plurality of second walls and the second rectangular base at the respective edge of the second rectangular base. In some embodiments, a shear wall is arranged along a side of the assembly corresponding to an edge of the rectangular base, and the shear wall is affixed to the cell carrier and to the second cell carrier.

In some embodiments, for example, the shear wall includes one or more mounting features.

In some embodiments, the present disclosure is directed to a method for making the battery housing for a vehicle battery system. The method includes receiving a cell carrier, formed as a single component, that is foldable. The method also includes folding the plurality of walls of the cell carrier to be perpendicular or angular to the rectangular base by flexing the plurality of integrated hinges. The method also includes forming an assembly having a plurality of battery cells and the cell carrier, and applying an adhesive to at least one of the plurality of walls and the plurality of battery cells to affix the plurality of walls to the assembly.

In some embodiments, the method includes arranging a shear wall along a lateral side of the assembly, and affixing the shear wall to the lateral side of assembly.

In some embodiments, the method includes forming a second assembly having a plurality of second battery cells, and forming a second cell carrier that encases the plurality of second battery cells. The method also includes folding the plurality of second walls of the cell carrier to be perpendicular to the second rectangular base by flexing the plurality of second integrated hinges. The method also includes applying an adhesive to the plurality of second walls to affix the plurality of second walls to the second assembly.

In some embodiments, each battery cell includes a first face affixed to the rectangular base and a second face opposite the first face. In some such embodiments, the method includes arranging a cooling plate to lie along each second face of the plurality of battery cell, and affixing the cooling plate to the plurality of battery cells.

In some embodiments, the method includes forming the cell carrier using injection molding. For example, a suitable liquid material may be injected into a pre-formed mold to form the cell carrier when solidified. In some embodiments, the method includes forming the cell carrier by machining a sheet of material having a uniform thickness. For example, a plastic plate of uniform thickness may be cut, milled, and drilled to form a cell carrier.

In some embodiments, the present disclosure is directed to a battery system configured to provide electric power to a vehicle, the battery system having battery cells, a cell carrier, and a shear wall. The battery cells have an end side and a set of lateral sides, which may correspond to a top and lateral sides, for example. The cell carrier is formed as a single component and includes (i) a base that at least partially encases the plurality of battery cells at the end side and (ii) a wall arranged along a first lateral side of the set lateral sides. The shear wall is arranged along a second lateral side of the set of lateral sides, wherein the second lateral side is arranged perpendicular to the first lateral side.

In some embodiments, the cell carrier includes a second wall arranged along a third lateral side of the set of lateral sides, wherein the third lateral side is arranged parallel to the first lateral side.

In some embodiments, the plurality of battery cells have a second end side opposite the end side, and the battery system includes a cooling plate affixed to the second end side.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 illustrates a perspective view of an illustrative cell carrier having two walls, in accordance with some embodiments of the present disclosure;

FIG. 2 illustrates a perspective view of the illustrative cell carrier of FIG. 1, in a folded configuration, in accordance with some embodiments of the present disclosure.

FIG. 3 illustrates a perspective view of an illustrative cell carrier having four walls, in accordance with some embodiments of the present disclosure.

FIG. 4 illustrates a perspective view of the illustrative cell carrier of FIG. 4, in accordance with some embodiments of the present disclosure;

FIG. 5 shows a perspective view of an illustrative cell carrier and assembly having a plurality of battery cells, in accordance with some embodiments of the present disclosure;

FIG. 6 shows a perspective view of an illustrative shear wall, in accordance with some embodiments of the present disclosure;

FIG. 7 shows side views of several illustrative hinges in unflexed and flexed configurations, in accordance with some embodiments of the present disclosure;

FIG. 8 shows a perspective view of an illustrative battery system, in accordance with some embodiments of this disclosure, in accordance with some embodiments of the present disclosure;

FIG. 9 show a top cross-sectional view of a portion of an illustrative battery system, in accordance with some embodiments of this disclosure;

FIG. 10 shows a perspective view of an exemplary battery assembly, in accordance with some embodiments of this disclosure; and

FIG. 11 shows a flowchart of illustrative process 500 for making a battery cell carrier with reinforcement walls, in accordance with some embodiments of the present disclosure.

### DETAILED DESCRIPTION

The present disclosure is directed to structural walls of a battery system and structural reinforcements attached thereon for battery systems. Vehicles powered by a plurality of battery cells should have the battery cells installed in a manner that is efficient for manufacturing purposes. To illustrate, the battery cells may be encased in a battery housing which may be secured to some structure within the vehicle body and/or frame. Some battery housing designs may lack features which assist in the installation of the battery cells within the vehicle body. This may require additional features, and components, be added to the battery housings to enable an installation process. These additional features may take up space within the vehicle body and may or may not be designed to withstand the conditions of operation that a vehicle powered by a plurality of battery cells experiences. Other battery housings encase and seal a plurality of battery cells from exposure to the environment that a vehicle body experiences. These other housings may or may not be designed to handle shear loads and other structure stressors once installed in a vehicle body. The loads experienced by the battery housings may be related to inertial forces caused by the motion of the vehicle and mounting point stress as the weight of the plurality of battery cells shifts. Additionally, the mounting points may experience stress events during installation as the manufacturing process may utilize the battery housing to aid in positioning the battery cells within the vehicle body and may utilize features of the battery housing to secure the battery cells to the vehicle body. This may lead to fractures in the battery housing which may compromise the sealing of the battery housing against the conditions experienced by the vehicle body.

The systems described herein address the battery system, and utilize a battery cell carrier connected to a plurality of walls which may utilize a plurality of hinges to enable rotation of the plurality of walls from a position planar with the cell carrier to a position encompassing the plurality of battery cells positioned on the battery cell carrier. In some embodiments, the present disclosure is directed to a battery system configured to provide electrical power to a vehicle. The battery system includes a plurality of battery cells fixed to a battery cells carrier which has at least two walls arranged along a lateral side of the cell carrier, such as the side along the width of the cell carrier. In some embodiments the at least two walls are arranged to be in a fixed position creating opposing faces perpendicular or otherwise angled to the cell carrier. In some embodiments the at least two walls includes two walls in a fixed position and two additional walls that are affixed to the cell carrier by hinges. In some embodiments the at least two walls include four walls that are affixed to the cell carrier by hinges.

In some embodiments, one or more shear walls may be installed, which may include a first element and a second element. In some embodiments, the first element corresponds to a majority of a height of the lateral side. The first element includes a first flange extending away from the lateral side of the assembly. The second element includes a second flange. The first flange and the second flange are layered together to form an interface. A reinforcement may be included to strengthen the flange. In some embodiments, the first element includes a first material thickness and the second element includes a second material thickness substantially equal to the first material thickness. In some embodiments, a resulting flange formed at the interface has a thickness equal to a sum of the first material thickness and the second material thickness. In some embodiments, the first element and the second element are welded together at the interface along a path proximal to and along the lateral side of the assembly. In some embodiments, at least one of the first element or the second element, or both, includes an electrical terminal for electrically grounding the shear wall (e.g., to a cooling plate, a frame member, or other electrical reference). In some embodiments, the first flange includes a first through feature for mounting to the vehicle, and a first alignment feature for locating the battery module relative to the vehicle. In some embodiments, the second flange includes a second through feature aligned with the first through feature, and a second alignment feature aligned with the first alignment feature. In some embodiments, the first element includes a third flange arranged at the bottom of the first element that extends underneath the assembly.

The cell carriers of the present disclosure allow the battery system or subassemblies thereof to be transported for vehicle installation as a single assembly that can have battery cells loaded onto it (e.g., to be installed within a vehicle body). This approach may reduce manufacturing time and the number of individual pieces required in the vehicle assembly process. Further, the apparatus of the present disclosure need not require additional features at the site of the vehicle assembly because the cell carrier and walls may include features for enabling vehicle installation. By incorporating shear walls, the system can withstand the loads experienced by the battery cells both during installation and during the lifetime of the vehicle, as well as include mounting features. The approach also addresses the deficiencies in sealing the battery cells against the environment of the vehicle because the walls are reinforced against the installation and vehicle use loads while also incorporating installation features to enable the assembly to be secured within the vehicle body without a risk of cracking or other breakage.

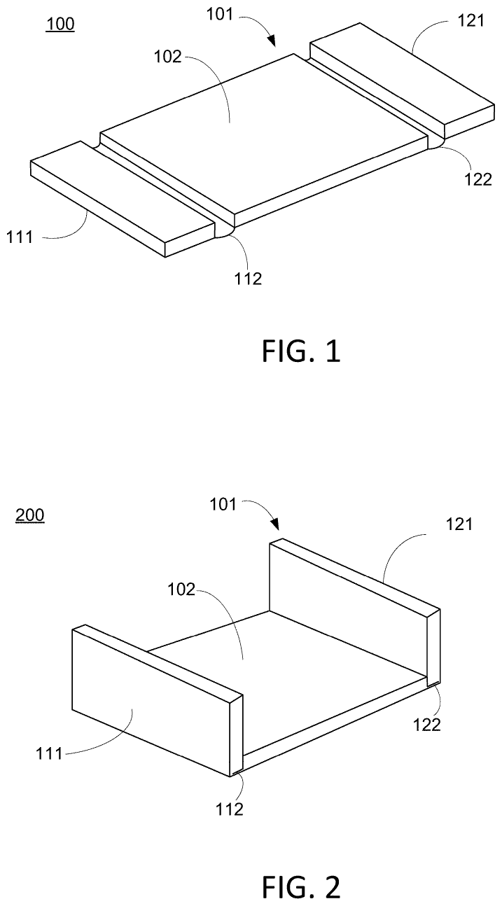

FIG. 1 illustrates a perspective view of illustrative cell carrier 101 having two walls 111 and 121, in accordance with some embodiments of the present disclosure. As illustrated, cell carrier 101 includes wall 111, integrated hinge 112, wall 121, integrated hinge 122, and base 102. In configuration 100, base 102 and walls 111 and 121 are arranged in a plane as a single, flat component. In some embodiments, cell carrier 101 is formed in configuration 100 by, for example, injection molding, pressing, stamping machining, any other suitable process, or any combination thereof

As illustrated, base 102 is rectangular, having four edges. Walls 111 and 121 are arranged at two opposite edges of base 102, with integrated hinges 112 and 122 arranged between respective walls 111 and 121 and base 102. Integrated hinges 112 and 122 may be formed as flex pivots, by causing the material of cell carrier 101 to be relatively thinner. The thinner material of integrated hinges 112 and 122 causes a reduced stiffness and thus walls 111 and 121 may be folded about respective integrated hinges 112 and 122.

FIG. 2 illustrates a perspective view of illustrative cell carrier 101 of FIG. 1, in a folded configuration (e.g., configuration 200), in accordance with some embodiments of the present disclosure. In some embodiments, cell carrier 101 is formed in configuration 100, and is folded into configuration 200 by arranging walls 111 and 121 perpendicular to base 102 by flexing integrated hinges 112 and 122. In some embodiments, cell carrier 101 is formed from plastic, a composite material including plastic, any other suitable material, or any combination thereof In some embodiments, cell carrier 101 is made from an electrically insulating material (e.g., to prevent electrical shorting of battery cells). Walls 111 and 121 can be folded at respective hinges 112 and 122 to form a perpendicular interface (e.g., either horizontal or vertical), an angled interface (e.g., at 45° or any other suitable angle), an interface resting on top of base 102, an interface lying to the side of base 102, any other suitable interface, or any combination thereof. In some embodiments, forming the cell carrier 101 from a single piece allows tighter tolerances.

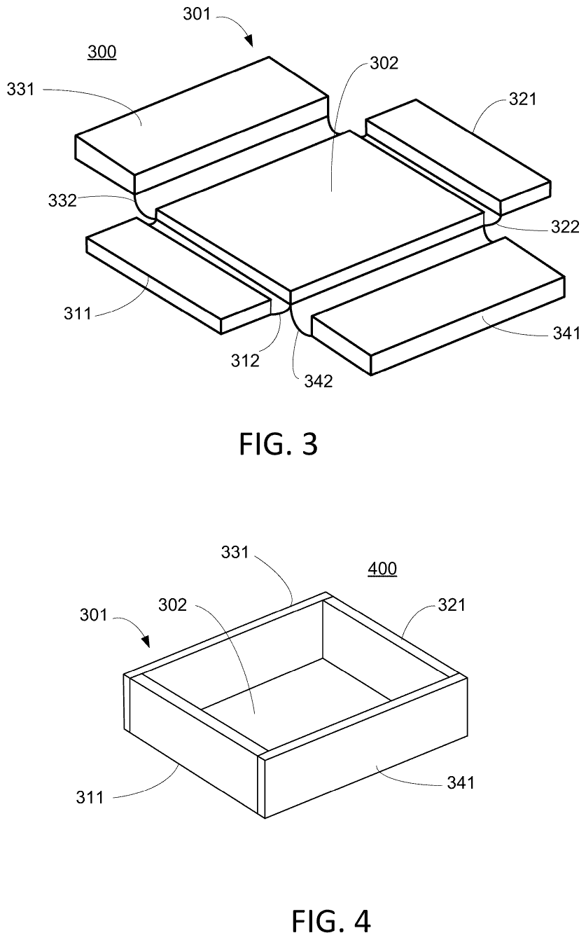

FIG. 3 illustrates a perspective view of illustrative cell carrier 301 with four walls 311, 312, 313, and 314, in accordance with some embodiments of the present disclosure. As illustrated, cell carrier 301 includes wall 311, integrated hinge 312, wall 321, integrated hinge 322, wall 331, integrated hinge 332, wall 341, integrated hinge 342, and base 302. In configuration 300, base 302 and walls 311, 321, 331, and 341 are arranged in a single plane as a single, flat component. In some embodiments, cell carrier 301 is formed in configuration 3100 by, for example, injection molding, pressing, stamping machining, any other suitable process, or any combination thereof

As illustrated, base 302 is rectangular, having four edges. Walls 311, 321, 331, and 341 are arranged at respective edges of base 302, with integrated hinges 312, 322, 332, and 342 arranged between respective walls 311, 321, 331, and 341, and base 102. Integrated hinges 312, 322, 332, and 342 may be formed as flex pivots, by causing the material of cell carrier 301 to be relatively thinner at the corresponding locations. The thinner material of integrated hinges 312, 322, 332, and 342 causes a reduced stiffness and thus walls 311, 321, 331, and 341 may be folded about respective integrated hinges 312, 322, 332, and 342.

FIG. 4 illustrates a perspective view of illustrative cell carrier 301 of FIG. 3, in a folded configuration (e.g., configuration 400), in accordance with some embodiments of the present disclosure. In some embodiments, cell carrier 301 is formed in configuration 300, and is folded into configuration 400 by arranging walls 311, 321, 331, and 341 perpendicular to base 302 by flexing integrated hinges 312, 322, 332, and 342. In some embodiments, cell carrier 301 is formed from plastic, a composite material including plastic, any other suitable material, or any combination thereof In some embodiments, cell carrier 301 is made from an electrically insulating material (e.g., to prevent electrical shorting of battery cells). In some embodiments, as illustrated, opposite walls of cell carrier 301 may be similar sizes, and may differ in size from other walls. For example, as illustrated, walls 311 and 321 may be of similar size, and walls 331 and 341 may be of similar size, and wall 311 may differ in size from wall 331. In an illustrative example, a cell carrier may include a pair of walls that are longer than a second pair of walls, corresponding to a rectangular base that is not square (e.g., squares being a subset of rectangles). Walls 311, 321, 331, and 341 can be folded at respective hinges 312, 322, 332, and 342 to form a perpendicular interface (e.g., either horizontal or vertical), an angled interface (e.g., at 45° or any other suitable angle), an interface resting on top of the base, an interface lying to the side of the base, any other suitable interface, or any combination thereof.

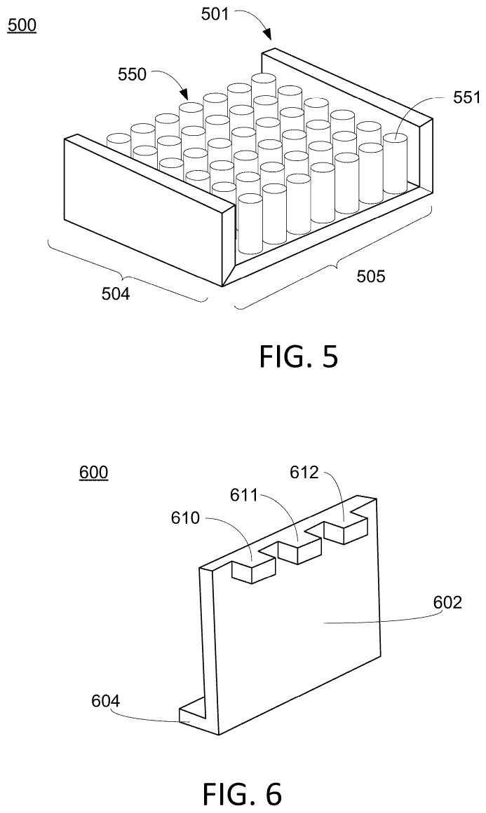

FIG. 5 shows a perspective view of illustrative cell carrier 501 and assembly 550 having a plurality of battery cells 551, in accordance with some embodiments of the present disclosure. As illustrated, cell carrier 501 is similar to cell carrier 101 of FIGS. 1-2 (e.g., having two walls arranged at opposite edges of the base). Assembly 500, which includes assembly 550 and cell carrier 501, may correspond to a battery module, and accordingly, may include current collectors, busbars, sensors, adhesives, fusible links (e.g., coupling plurality of battery cells 551 to one or more current collectors), a cooling plate (e.g., for removing heat or otherwise regulating temperature of plurality of battery cells 551), a shear wall, any other suitable components, or any combination thereof (not illustrated). In some embodiments, each battery cell of plurality of battery cells 551 is a cylindrical cell with both positive and negative electrodes arranged at the end nearest the base of cell carrier 501 (e.g., the bottom, as illustrated). In some such embodiments, cell carrier 501 may be electrically non-conductive (e.g., isolating) to prevent electrical shorting. In some embodiments, the ends of plurality of battery cells 551 arranged away from the base of cell carrier 501 may be affixed to a cooling plate (not shown) using an adhesive (e.g., a thermally conductive adhesive).

As illustrated, cell carrier 501 includes two walls arranged at opposite edges, corresponding to dimension 504. Further, as illustrated, cell carrier 501 does not include walls corresponding to dimension 505, and accordingly, a shear wall may be affixed along the side of assembly 500 corresponding to dimension 505 (e.g., or two shear walls, one each at each of the two open lateral sides).

FIG. 6 shows a perspective view of illustrative shear wall 600, in accordance with some embodiments of the present disclosure. As illustrated, shear wall 600 includes wall 602, feature 604, and mounting features 610, 611, and 612. In some embodiments, for example, shear wall 600 may installed with assembly 500 to form a battery system. For example, shear wall 600 may be affixed to an assembly such as assembly 500 against a lateral side (e.g., along the open side corresponding to dimension 505). Shear wall 600 is configured to provide stiffness to a battery system, as well providing an interface for mounting the battery system. Mounting features 610-612 extend out laterally from wall 602, and are configured to be affixed to a vehicle frame or body. Feature 604 is configured to, for example, locate a battery system, provide stiffness, provide support (e.g., for the weight of the battery system), or combination thereof. Feature 604 may include locating features (e.g., holes, slots, pins, steps, lips), mounting features (e.g., flanges, holds, studs, interlocks), any other suitable features, or any combination thereof. In some embodiments, shear wall 600 is formed from metal. For example, shear wall 600 may be stamped from sheet metal (e.g., sheet steel) and bent into a final shape. In a further example, components may be welded to wall 602 to form shear wall 600. In some embodiments, shear wall 600 is formed from plastic.

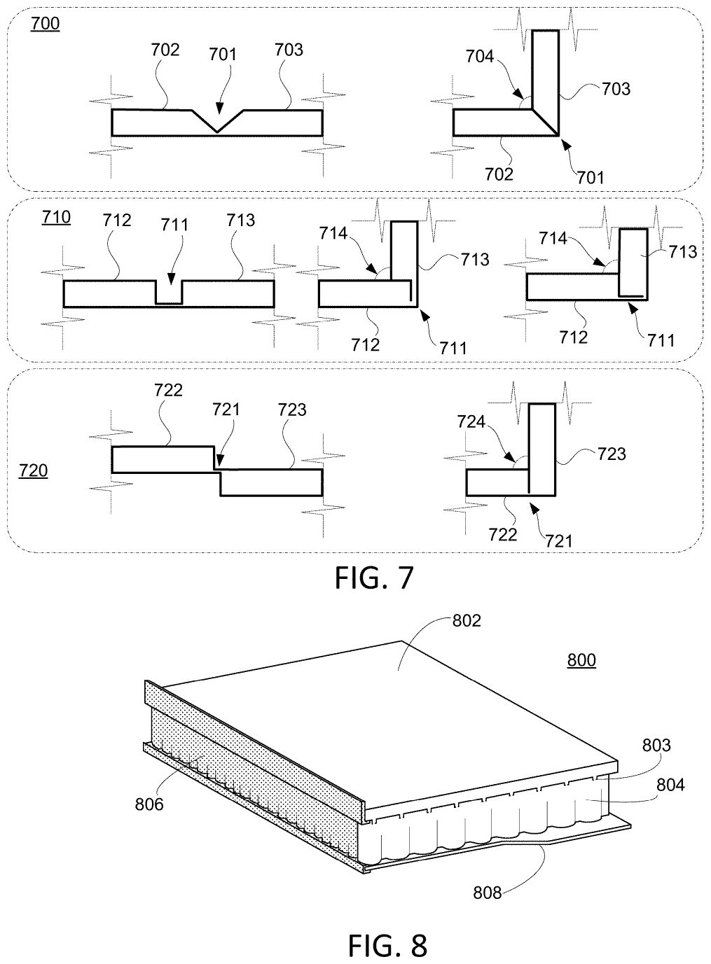

FIG. 7 shows side views of several illustrative hinges in unflexed and flexed configurations, in accordance with some embodiments of the present disclosure. Panels 700, 710, and 720 show illustrative integrated hinges in flexed and unflexed positions, with walls bent relative to a base. Panel 700 illustrates hinge 701 arranged in between base 702 and wall 703. As illustrated, wall 703 may be folded at hinge 701, so transition from being in-plane with base 702 to being perpendicular to base 702. In some embodiments, adhesive 704 is applied to the interface (e.g., the seam, before or after folding) between base 702 and wall 703 to increase rigidity. Panel 710 illustrates hinge 711 arranged in between base 712 and wall 713. As illustrated, wall 713 may be folded at hinge 711, so transition from being in-plane with base 712 to being perpendicular to base 712. In some embodiments, adhesive 714 is applied to the interface (e.g., the seam, before or after folding) between base 712 and wall 713 to increase rigidity. As illustrated, wall 713 may be folded on top of, or next to, base 712 (e.g., each is illustrated in panel 710, although one configuration may be preferred). Panel 720 illustrates hinge 721 arranged in between base 722 and wall 723. As illustrated, wall 723 may be folded at hinge 721, so transition from being roughly in-plane with base 722 (e.g., parallel to but offset by about a thickness of wall 722) to being perpendicular to base 722. In some embodiments, adhesive 724 is applied to the interface (e.g., the seam, before or after folding) between base 722 and wall 723 to increase rigidity. In some embodiments, a cell carrier may be formed by flexing hinges that are already in a first flexed configuration to a second flexed configuration. Accordingly, in some embodiments, the cell carrier is folded from a first flexed position to a second flexed position.

FIG. 8 shows a perspective view of illustrative battery system 800, in accordance with some embodiments of the present disclosure. As illustrated, battery assembly 800 includes cell carrier 802, a plurality of battery cells (e.g., not visible in FIG. 8), shear wall 806, and cooling plate 808. To form battery assembly 800, the plurality of battery cells may be affixed to cell carrier 802, and the walls (e.g., of which wall 804 is one) of cell carrier 802 may be folded perpendicular to the base of cell carrier 802 (e.g., in either order as may be suitable), via hinges 803. Cooling plate 808 is affixed to the plurality of battery cells, at the opposite end from that affixed to the cell carrier base. Shear wall 806 is affixed to a lateral side of the subassembly (e.g., cell carrier 802, the plurality of battery cells, and cooling plate 808). Adhesive may be applied between any or each suitable interface of components to provide rigidity and constrain relative movement of the components. In some embodiments, although not illustrated in FIG. 8, a second cell carrier and a second plurality of battery cells may be affixed to the other side of cooling plate 808 (e.g., the bottom as illustrated, opposite cell carrier 802), and accordingly shear wall 806 may extend along the entire lateral side (e.g., shear wall 806 would roughly double in height as that illustrated in FIG. 8).

In some embodiments, shear wall 806 includes a first element and a second element, arranged along a lateral side of the plurality of battery cells. In some embodiments, for example, the first element corresponds to a majority of a height of the lateral side, and includes a first flange extending away from the lateral side of the assembly. In some embodiments, the second element includes a second flange. To illustrate, the first flange and the second flange may be layered together to form an interface, optionally with a reinforcement included to strengthen the flange (e.g., which may be a mounting feature for mounting battery system 800 to a vehicle). In some embodiments, shear wall 806 includes the first element having a first material thickness and the second element having a second material thickness that is about equal to the first material thickness. In some embodiments, a resulting flange for mounting is formed at the interface has a thickness equal to a sum of the first material thickness and the second material thickness. In some embodiments, the first element and the second element are welded together at the interface along a path proximal to and along the lateral side of the assembly. Shear wall 806 may be formed from a single piece of material, or by joining two or more pieces of material (e.g., abutted or overlapping).

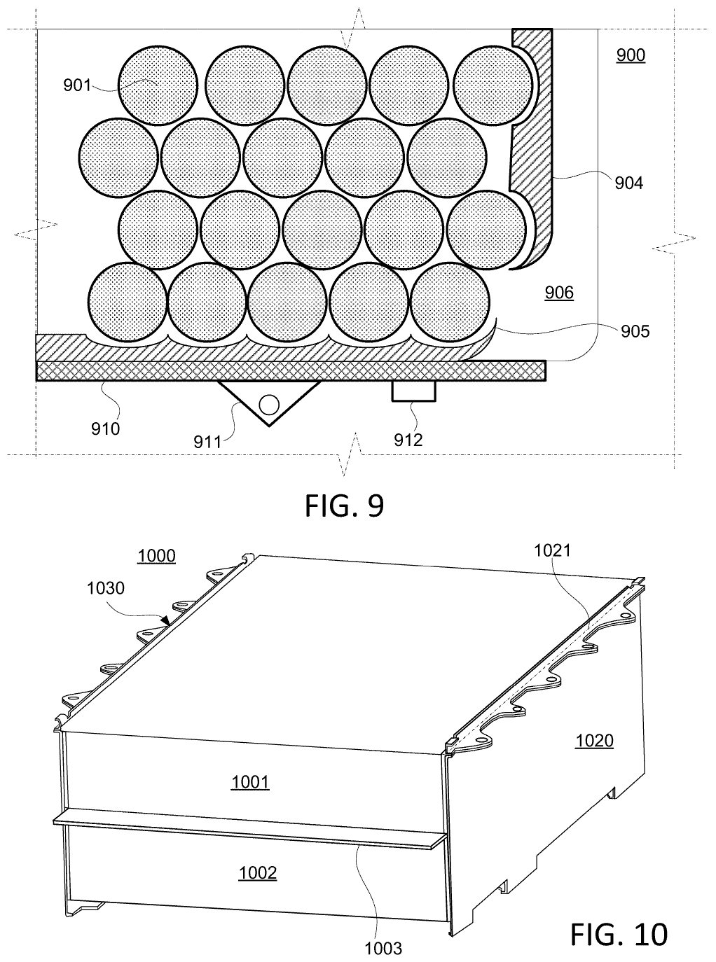

FIG. 9 show a top cross-sectional view of a portion of illustrative battery system 900, in accordance with some embodiments of the present disclosure. As illustrated, battery system 900 includes battery cells 901 (e.g., a plurality of battery cells coupled in series and/or parallel via one or more current collectors or busbars), walls 904 and 905 (e.g., of a cell carrier), cooling plate 906, and shear wall 910, which may be affixed together to form an assembly. As illustrated, shear wall 910 includes mounting features 911 and 912. Battery cells 901 are arranged between cooling plate 906 and a base of the cell carrier (e.g., the base is not visible in FIG. 9). Walls 904 and 905, along with corresponding walls on opposite lateral sides (not visible in FIG. 9) are folded perpendicular to the base, to extend along lateral sides of battery cells 901. As illustrated, walls 904 and 905. Shear wall 910 is affixed to a lateral side of the assembly using, for example, fasteners, mechanical interlocks, crimps, clamps, an adhesive, any other suitable affixment, or any combination thereof. Mounting features 911 and 912 is configured to engage with a frame of the vehicle for mounting. For example, mounting feature 911, mounting feature 912, or both, may include a hole, a stud (e.g., threaded stud), a pin (e.g., for aligning), a tab (e.g., for welding or mechanically engaging such as crimping), any other suitable feature for interfacing to the vehicle or frame thereof, or any combination thereof. To illustrate, once assembled batter system 900 may moved or installed by applying force at features of shear wall 910 rather than the cell carrier or walls 904 or 905 thereof.

FIG. 10 shows a perspective view of illustrative battery system 1000, in accordance with some embodiments of this disclosure. As illustrated, battery system 1000 includes shear wall 1020, shear wall 1030 arranged on the opposite lateral side from shear wall 1020, first module 1001 (e.g., having a plurality of battery cells), second module 1002 (e.g., having a plurality of battery cells, and cooling plate 1003 to which first module 1001 and second module 1002 are affixed (e.g., using adhesive). Shear wall 120, as illustrated, includes flange 1021, as illustrated, includes extensions that are configured for attachment to a frame member of a vehicle. Flange 1021, as illustrated, includes mounting features and alignment. To illustrate, battery system 1000 may be configured to provide electric power to a vehicle. In some embodiments, battery system 1000 includes a first plurality of battery cells arranged in first module 1001, a second plurality of battery cells arranged in second module 1002, and cooling plate 1003 coupled between first module 1001 and second module 1002 to form a first assembly. As illustrated, battery system 1000 includes shear walls 120 and 130, which are attached to the first assembly on lateral sides of the first assembly. Although two shear walls are illustrated, a battery system may include one shear wall, two shear walls, or more than two shear walls, in accordance with the present disclosure. Each of shear walls 120 and 130 includes a flange (e.g., flange 1021) that extends away from the lateral side of the first assembly (e.g., from near the plurality of battery cells outwards).

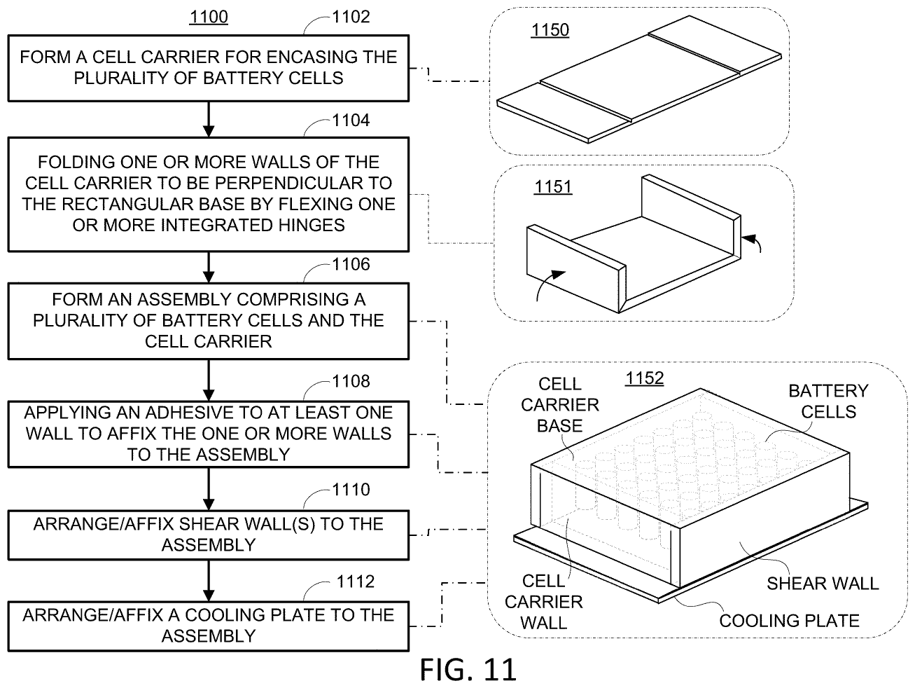

FIG. 11 shows a flowchart of illustrative process 1100 for making a battery cell carrier with reinforcement walls, in accordance with some embodiments of the present disclosure. In an illustrative example, process 1100, or steps thereof, may be used to form cell carrier 100, 200, and 300 of FIGS. 1-4, assembly 500 of FIG. 5, battery system 800 of FIG. 8, battery system 900 of FIG. 9, battery system 1000 of FIG. 10, or any combination thereof

Step 1102 includes forming a cell carrier configured to encase a plurality of battery cells. In some embodiments, the cell carrier is formed as a single, foldable component. The cell carrier includes a base (e.g., a rectangular base), one or more walls (e.g., one wall, or a plurality of walls) arranged along respective edges of the base, and one or more integrated hinges (e.g., one integrated hinge, or a plurality of integrated hinges). Each integrated hinge is arranged between a respective wall of the plurality of walls and the base at the respective edge. For example, panel 1150 illustrates a cell carrier formed as a flat structure with flex pivots (e.g., hinges) for folding. To illustrate further, the cell carrier may be formed by stamping a sheet of material, cutting a piece of material, machining a piece of material, injection molding using a suitable material, any other suitable process, or any combination thereof. In some embodiments, the flat cell carrier, prior to folding, may be formed to have a thickness that is substantially uniform except for the hinges, which may exhibit a reduced thickness (e.g., to allow flexing). In some embodiments, the cell carrier may include one or more recess features (e.g., through features) for accessing terminals of battery cells, accommodating electrical links from current collectors to the battery cells, accommodating sensor wires, allowing airflow, reducing mass, accommodating boss features of other components during assembly, any other suitable purpose, or any combination thereof.

Step 1104 includes folding the one or more walls of the cell carrier to be perpendicular to the base by flexing the plurality of integrated hinges. For example, panel 1151 illustrates walls that have been folded perpendicular with a rectangular base. In some embodiments, the folded cell carrier may include interfaces corresponding to the hinges that arise from folding. For example, when folded, an interface surface may be created between the base and the wall, or between walls if when folded the walls share an edge (not illustrated in FIG. 11, but illustrated in FIG. 4). In some embodiments, step 1104 includes applying adhesive to the interfaces between walls, between a wall and the base, in a recess corresponding to the hinge, or a combination thereof.

Step 1106 includes forming an assembly comprising a plurality of battery cells. In some embodiments, step 1106 includes forming and/or arranging the battery cells against the base of the cell carrier having the one or more walls already folded. In some embodiments, step 1106 includes forming and/or arranging the battery cells against the base of the cell carrier and the walls being folded after arrangement. Accordingly, steps 1104 and 1106 may be performed in any suitable order, or be performed at the same time.

Step 1108 includes applying an adhesive to the plurality of walls to affix the one or more walls to the assembly. In some embodiments, step 1108 includes applying adhesive to the interfaces between battery cells, between battery cells and walls, between battery cells and the base, between battery cells and a cooling plate (e.g., wherein step 1110 may be performed during or before steps 1106 and 1108), to any other suitable interface, or any combination thereof. In some embodiments, step 1108 is performed before or at the same time as step 1104. In some embodiments, steps 1106 and 1108 may be performed as a single step or otherwise at the same time. In some embodiments, steps 1104, 1106, and 1108 may be performed as a single step or otherwise at the same time.

Step 1110 includes arranging one or more shear walls along one or more lateral sides of the assembly. In some embodiments, step 1110 includes affixing the shear wall to the assembly and to the cell carrier. For example, step 1110 may include applying an adhesive at the interface between the assembly (e.g., battery cells, cell carrier, or both) and the shear wall.

Step 1112 includes arranging a cooling plate along the assembly, arranged opposite the cell carrier. In some embodiments, the plurality of battery cells each include a first face affixed to the base and a second face opposite the first face. For example, each battery cell may be cylindrical, with a positive and negative terminal at the first face (e.g., concentric terminals including a center portion and a rim portion). In some embodiments, step 1112 includes arranging the cooling plate along each second face of the plurality of battery cells. For example, the second faces of the battery cells may lie in a plane, and the cooling plate may be arranged at the plane (e.g., to achieve contact for removing heat from each battery cell). In some embodiments, step 1112 includes affixing the cooling plate to the plurality of battery cells. For example, step 1112 may include applying an adhesive at the interface between the battery cells and the cooling plate. In a further example, the adhesive may include a thermal conductivity suitable for transferring heat from the battery cells to the cooling plate. In some embodiments, step 1112 is performed before step 1110 (e.g., before adding the shear wall), or at about the same time as step 1110 (simultaneously). For example, the cooling plate may be adhered to faces of the battery cells, opposite the base of the cell carrier, before or after installation of the shear wall.

In some embodiments, process 1100 includes repeating one or more of steps 1102-1112 to, for example, include more than one assembly in a battery system (e.g., as illustrated by battery system 1000 of FIG. 10). For example, process 110 may include forming a second assembly having a plurality of second battery cells, and forming a second cell carrier that encases the plurality of second battery cells. The second cell carrier is a single, foldable component, similar to the first cell carrier. For example, the second cell carrier includes a base, a plurality of walls arranged along respective edges of the, and a plurality of integrated hinges arranged between a respective wall and the base (e.g., at the edges of the base). Process 1100 may include folding the plurality of walls of the second cell carrier to be perpendicular to the base by flexing the plurality of integrated hinges. In some embodiments, process 1100 includes applying an adhesive to the plurality of walls of the second cell carrier to affix the plurality of second walls to the second assembly. In some embodiments, process 1100 (e.g., step 1112 thereof) includes arranging the cooling plate between the first and second battery assemblies. For example, a respective cell carrier and respective plurality of battery cells may be arranged on either side of the relatively flat cooling plate.

The foregoing is merely illustrative of the principles of this disclosure, and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A battery system configured to provide electric power to a vehicle, the battery system comprising:
a cell carrier configured to at least partially encase a plurality of battery cells, wherein the cell carrier comprises:
one or more walls arranged along respective edges of a rectangular base; and
one or more integrated hinges, each integrated hinge arranged between a respective wall of the one or more walls and the respective edges of the rectangular base.

2. The battery system of claim 1, wherein the rectangular base comprises:
a first pair of lateral sides opposite each other that are a first length; and
a second pair of lateral sides opposite each other that are a second length that is longer than the first length.

3. The battery system of claim 2, further comprising one or more wall reinforcements affixed along the second pair of lateral sides.

4. The battery system of claim 3, wherein the one or more wall reinforcements are further comprised of structural tabs.

5. The battery system of claim 1, wherein the cell carrier is configured to achieve:
a first state wherein the one or more walls and the rectangular base lie in a plane as a flat structure and wherein the one or more integrated hinges are unflexed; and
a second state wherein the one or more walls are arranged perpendicular to the rectangular base and wherein the one or more integrated hinges are flexed.

6. The battery system of claim 1, further comprising an adhesive arranged along each of the one or more integrated hinges to maintain an orientation of each respective wall of the one or more walls and the rectangular base.

7. The battery system of claim 1, wherein the one or more walls comprises:
a first wall arranged at a first edge of the rectangular base;
a second wall arranged at a second edge of the rectangular base opposite to the first edge, and wherein the battery system further comprises:
a shear wall arranged along a side of the assembly corresponding to a third edge of the rectangular base, wherein the shear wall is affixed to the cell carrier, and wherein the shear wall comprises one or more mounting features.

8. The battery system of claim 1, further comprising a cooling plate having a first side and a second side opposite the first side, wherein the plurality of battery cells each comprise:
a first face affixed to the rectangular base; and
a second face opposite the first face, wherein the second face is affixed to the first side of the cooling plate.

9. The battery system of claim 8, further comprising a second assembly arranged along the second side of the cooling plate, the second assembly comprising:
a second plurality of battery cells; and
a second cell carrier that encases the second plurality of battery cells, wherein the cell carrier comprises:
a second rectangular base;
one or more second walls arranged along respective edges of the second rectangular base; and
a plurality of second integrated hinges, each second integrated hinge arranged between a respective second wall of the one or more second walls and the second rectangular base at the respective edge of the second rectangular base.

10. The battery system of claim 9, further comprising a shear wall arranged along a side of the assembly corresponding to an edge of the rectangular base, wherein the shear wall is affixed to the cell carrier and to the second cell carrier, and wherein the shear wall comprises one or more mounting features.

11. A method for making a battery housing for a vehicle battery system, the battery system comprising:
forming a cell carrier, wherein the cell carrier is foldable, and wherein the cell carrier comprises a base, one or more walls arranged along respective edges of the base, and one or more integrated hinges, each integrated hinge of the one or more integrated hinges arranged between a respective wall of the one or more walls and the base at the respective edge;
folding the one or more walls of the cell carrier to be perpendicular to the base by flexing the one or more integrated hinges and to at least partially encase a plurality of battery cells; and
applying an adhesive to at least one wall of the one or more walls and a plurality of battery cells to affix the at least one wall to the assembly.

12. The method of claim 11, further comprising:
arranging a shear wall along a lateral side of the assembly; and
affixing the shear wall to the lateral side of assembly.

13. The method of claim 11, further comprising:
forming a second assembly comprising a plurality of second battery cells; and
forming a second cell carrier that encases the plurality of second battery cells, wherein the second cell carrier is a single component, wherein the second cell carrier is foldable, and wherein the second cell carrier comprises a second base, one or more second walls arranged along respective edges of the second base, and one or more second integrated hinges, each second integrated hinge arranged between a respective wall of the one or more second walls and the second base at the respective edge of the second base;
folding the one or more second walls of the cell carrier to be perpendicular to the second base by flexing the one or more second integrated hinges; and
applying an adhesive to the one or more second walls to affix the one or more second walls to the second assembly.

14. The method of claim 11, wherein the plurality of battery cells each comprise a first face affixed to the base and a second face opposite the first face, the method further comprising:
arranging a cooling plate to lie along each second face of the plurality of battery cells; and
affixing the cooling plate to the plurality of battery cells.

15. The method of claim 11, further comprising forming the cell carrier using injection molding.

16. The method of claim 11, further comprising forming the cell carrier by machining a sheet of material having a uniform thickness.

17. A battery system configured to provide electric power to a vehicle, the battery system comprising:
a plurality of battery cells having an end side and a set of lateral sides;
a cell carrier formed as a single component, wherein the cell carrier comprises:
a base that at least partially encases the plurality of battery cells at the end side, a wall arranged along a first lateral side of the set lateral sides; and
a shear wall arranged along a second lateral side of the set of lateral sides, wherein the second lateral side is arranged perpendicular to the first lateral side.

18. The battery system of claim 17, wherein the cell carrier comprises a second wall arranged along a third lateral side of the set of lateral sides, wherein the third lateral side is arranged parallel to the first lateral side.

19. The battery system of claim 17, wherein the plurality of battery cells have a second end side opposite the end side, the battery system further comprising a cooling plate affixed to the second end side.

20. The battery system of claim 17, wherein the bases is a rectangular base, wherein the second lateral side corresponds to an edge of the rectangular base, and wherein the shear wall comprises one or more mounting features for mounting to the vehicle.
